(19) United States
(12) Patent Application Publication
(10) Pub. No.: US 2006/0022179 A1
(43) Pub. Date: Feb. 2, 2006

(54) Screw jack for structures for easily adjusting its angle

(76) Inventor: Sang-Hwan Oh, Seoul (KR)

Correspondence Address: Robert E. Bushnell;Suite 300, 1522 K Street, N.W., Washington, DC, 20005-1202, US

(21) Appl. No.: 11/190,813

(22) Filed: Jul. 28, 2005

(30) Foreign Application Priority Data
Jul. 28, 2004 (KR) 10-2004-0059171

(51) Int. Cl. B66F 3/08

(52) U.S. Cl. 254/98

(57) ABSTRACT

A structural screw jack capable of easily accommodating adjustment of its angle of inclination. The screw jack can allow the orientation of a chute located at one end of the screw jack is be adjusted to define either a right angle to the longitudinal axis of the jack, or over a range of oblique angles relative to its longitudinal axis so that the screw jack may be installed at an oblique angle between earlier installed vertical and horizontal oriented structural steel shapes, and thereby enabling a reduction in the number of process steps customarily used during field installation of diagonal braces supported by a screw jack. The screw jack includes a lower coupling shaft, a lower jack, and a steel bar. The upper jack includes an upper coupling pipe having a plurality of reinforcing ribs formed on the outer side surface thereof, and an upper holder closely coupled to the outer side surface of the upper coupling. One end of the lower coupling shaft is integrated at its one end to the lower portion of the upper coupling pipe. The other end of the lower coupling shaft having a predetermined curvature forming a rack thereon and has a through hole formed in the cross direction of the lower coupling shaft. The lower jack includes a chute in which pinions are formed to be meshed with the rack, and coupling holes located at both sides of the chute member are formed. A lower holder which is closely coupled to the outer surface of the chute.

### CLAIM OF PRIORITY

This application makes reference to, incorporates the same herein, and claims all benefits accruing under 35 U.S.C.§119 from an application for SCREW JACK FOR STRUCTURES FOR EASILY ADJUSTING ITS ANGLE earlier filed in the Korean Intellectual Property Office on the 28 Jul. 2004, and there duly assigned Serial No. KR2004-59171.

### BACKGROUND OF THE INVENTION

### 1. Field of the Invention

The present invention relates to a screw jack capable of easily adjusting its angle of inclination relative to a structure being supported, and, more particularly, to a screw jack for structures which is capable of easily adjusting a chute member located at one end of the screw jack, to enable the screw jack to be readily and accurately adjustably installed obliquely against vertical and horizontal steel structural shapes.

2. Description of the Related Art

Generally, screw jacks such as have been disclosed in Korean Utility Model Application No. 20-1999-3277, filed in the Korean Intellectual Property Office on Mar. 3, 1999, provide no accommodation to enable the jack to be installed to adjustably support a strut positioned at an oblique angle relative to a retaining wall or a wale, such as an H-beams.

Even with those adjustable screw jacks fitted with an obliquely sloped bottom plate, the bottom plates is integrated with the cylindrical body of a lower coupling pipe. Consequently, the angle of inclination is fixed, which, in turn, limits the usefulness of the screw jack to provide bracing, or other angular support to excavated earthen or structural steel shapes, at anything other than a predetermined angle. Consequently, with the lower base plate of the screw jack fixed at a predetermined angle, the longitudinally opposite end of the strut, or brace, supported by the jack screw must be cut, and fitted, at the job site, in order to be installed at an oblique angle against the earth or structural steel shape. Depending on conditions at the construction site however, this is a difficult task to perform quickly and accurately; usually one or more filling members, or shims, must be cut and then carefully inserted between the strut supported by the screw jack and the earthworks or structural steel shape braced by the strut. This is a tedious, time consuming and unwelcome task which must be performed on the job site for each strut.

### SUMMARY OF THE INVENTION

Therefore, the present invention has made in view of the above problems, and it is an object of the present invention to provide a screw jack for structures which is capable of adjusting a chute member located at one end of the screw jack such that angles of the screw jack to be installed to vertical and horizontal shape steels can be easily adjusted, of reducing the number of working processes, such as attaching holding shape steels to a vertical and a horizontal shape steels, and cutting holding shape steels, thereby enhancing working efficiency, and of minimizing waste of the holding shape steels.

It is another object to provide a screw jack and process that enable field erection and accurate placement of obliquely oriented structural members.

It is still another object to provide a screw jack and process that readily enables oblique positioning of structural members during field erection, at angular orientations that accurately conform to earlier erected structural members.

It is yet another object to provide a screw jack and process that permits angular adjustment of the base plate to accommodate a wide range of adjustable, angularly oblique positions between the struts, braces or other structural members supported by the screw jack, and earlier erected structural members.

In accordance with the present invention, these and other objects may be accomplished in the practice of the instant invention with the provision of a structural screw jack capable of easily adjusting its angle of inclination. This screw jack may be constructed with an upper jack, a lower coupling shaft, a lower jack, and a steel bar. The upper jack includes an upper coupling pipe with an outer side surface and a plurality of reinforcing ribs extending between the outer side surface and an upper holder. The upper holder is closely coupled to the outer side surface of the upper coupling. The the upper holder is shaped as a plate. The lower coupling shaft is shaped as a bar. One end of the lower coupling shaft is integrated at its one end with the lower portion of the upper coupling pipe. The distal portions of other end of the lower coupling shaft exhibit a predetermined curvature with a rack formed around the curvature, and a through hole formed transversely to the curvature, through the lower end of the coupling shaft. The lower jack includes a chute, in which pinions are formed to be meshed with the rack, and coupling holes located in both side walls of the chute. A lower holder which is closely coupled to the outer surface of the chute member, in which the lower holder is shaped to form a base plate. The steel bar, or pin, is inserted into the coupling hole of the lower coupling shaft and the coupling holes of the chute to couple the lower end of the coupling shaft to the chute.

### BRIEF DESCRIPTIONS OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components wherein:

FIG. 1 is a view illustrating a construction state of a typical disposition of a temporary sheeting structure erected in an earthen excavation;

FIG. 2 is a side view illustrating a screw jack found among the prior art;

FIG. 3 is a view illustrating a screw jack representing one embodiment of the prior art is installed to support a temporary sheeting structure;

FIG. 4 is a view illustrating a screw jack representing another embodiment of the prior art is installed to support a temporary sheeting structure;

FIG. 5 is an oblique view illustrating a structural screw jack capable of easily accommodating adjustment of its angle of inclination in accordance with the practice of a first embodiment of the principles of the present invention;

FIG. 6 is a side elevation view illustrating one embodiment of a structural screw jack capable of easily accommodating adjustment of its angle of inclination in accordance with the practice of a first embodiment of the present invention;

FIG. 7 is a partially exploded oblique view illustrating a structural screw jack capable of easily accommodating adjustment of its angle of inclination in accordance with the practice of the first embodiment of the present invention;

FIG. 8 is an elevation view illustrating the operating states of a structural screw jack capable of easily accommodating adjustment of its angle of inclination in accordance with the practice of the first embodiment of the present invention;

FIG. 9 is an oblique view illustrating a structural screw jack capable of easily accommodating adjustment of its angle of inclination in accordance with the practice of a second embodiment of the present invention;

FIG. 10 is a front elevation view illustrating the structural screw jack capable of easily accommodating adjustment of its angle of inclination in accordance with the practice of the second embodiment of the present invention;

FIG. 11 is a partially exploded oblique view illustrating the structural screw jack capable of easily accommodating adjustment of its angle of inclination in accordance with the practice of the second embodiment of the present invention;

FIG. 12 is an elevation view illustrating operating states of the structural screw jack capable of easily accommodating adjustment of its angle of inclination in accordance with the practice of the second embodiment of the present invention; and

FIG. 13 is an elevation view illustrating one installation of a structural screw jack capable of easily accommodating adjustment of its angle in accordance with the present invention to brace a previously installed vertical steel structural shape.

### DETAILED DESCRIPTION OF THE PREFERRED EMBODIMENT

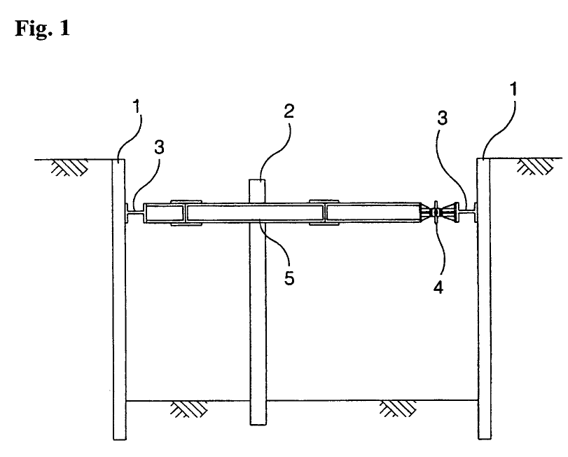

Referring now to the drawings, FIG. 1 shows a typical strut type sheeting structure set up at a construction site so that retaining walls 1 and an intermediate pile 2 are firstly driven into the earth, a quantity of the earth is excavated from the site up to a predetermined position, one, or more wales 3, such as H-beams, are installed thereto, and strut 5 is installed to hold wales 3 in place.

Here, strut 5 has a screw jack 4 attached to one of its ends so that strut 5 can be adjusted in length. Such a screw jack 4 has been disclosed in Korean Utility Model Application No. 20-1999-3277, filed in the Korean Intellectual Property Office on the 3 Mar. 1999.

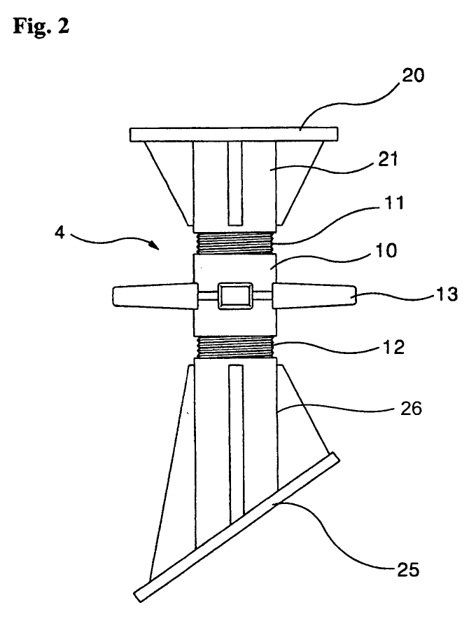

As shown in FIG. 2, screw jack 4 includes a body 10 which has a plurality of handles 13 extending radially outwardly from the sides of body 10, axially between upper and lower screws 11, 12 at the upper and lower sides of handles 10, respectively. In addition, screw jack 4 includes upper and lower coupling pipes 21, 26, which are coupled to upper and lower screws 11, 12, respectively. Screw jack 14 includes upper and lower holders 20, 25, which are formed as integrated component parts of upper and lower coupling pipes 21, 26, respectively, and which support the earth or steel structural shapes. Here, lower holder 25 is sloped with a fixed, predetermined angle relative to the longitudinal axis of jack 4.

Upper and lower screws 11, 12 are helically cut as spirals formed in opposing directions so that, when the handles 13 are rotated, upper and lower holders 20, 25 can be simultaneously moved to be brought either closer or farther apart from one another.

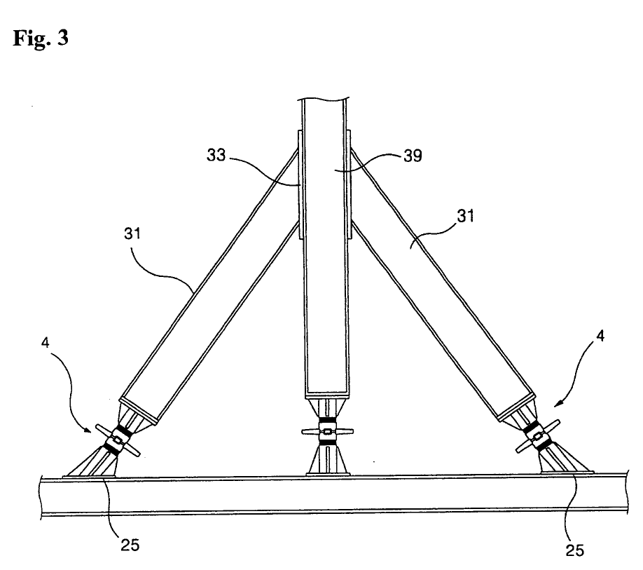

As shown in FIG. 3, when a vertically positioned steel shape 37 is supported and held in place by obliquely positioned structural steel shapes 31 each of which mounts a screw jack 4 of a prior art design at its lower end, lower holder 25 of each screw jack 4 must be cut at a fixed, predetermined angle, depending on the specific conditions at the construction site. Moreover, the other end 33 of the bracing steel structural shape 31, which is longitudinally opposite to screw jack 4, must be cut to a precise length and be then fitted at a fixed, oblique angle.

It is generally difficult to accurately cut both lower holder 25 of screw jack 4 as well as the longitudinally opposite end 33 of steel structural shape 31 in the field, especially at a construction site, because field conditions are especially inimical to accurate metal work. On the other hand, if the opposite distal end 33 of bracing structural steel shape 31 is not precisely cut at a fixed, predetermined angle which conforms precisely to vertical steel shape 37, a shim or other filling member must be inserted between the upper distal end of structural steel shape 31 and vertically extending steel shape 37.

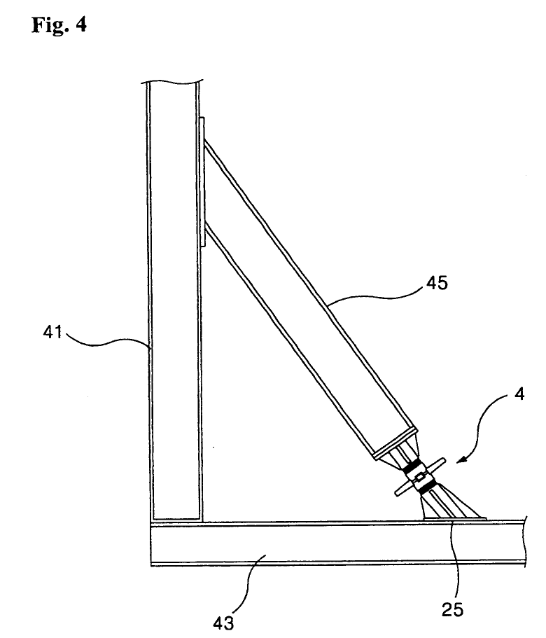

As shown in FIG. 4, when screw jack 4 found in the prior art is attached to a steel structural shape 45 which is positioned to create a supporting connection between wale 41, for example, which has been erected as a vertical structural steel shape, and wale 43, for example, a horizontally extending structural steel shape, it is difficult to quickly and accurately cut lower holder 25 of screw jack 4 and the other end of the holding shape steel 45 at the construction site. In addition, if the other end of obliquely oriented steel shape 45 which has been erected as a brace, is not correctly and precisely fitted to wale 41, which is a vertically positioned steel shape, a shim, filler, or other filling member must be inserted between wale 41 and the distal end of the bracing steel shape 45.

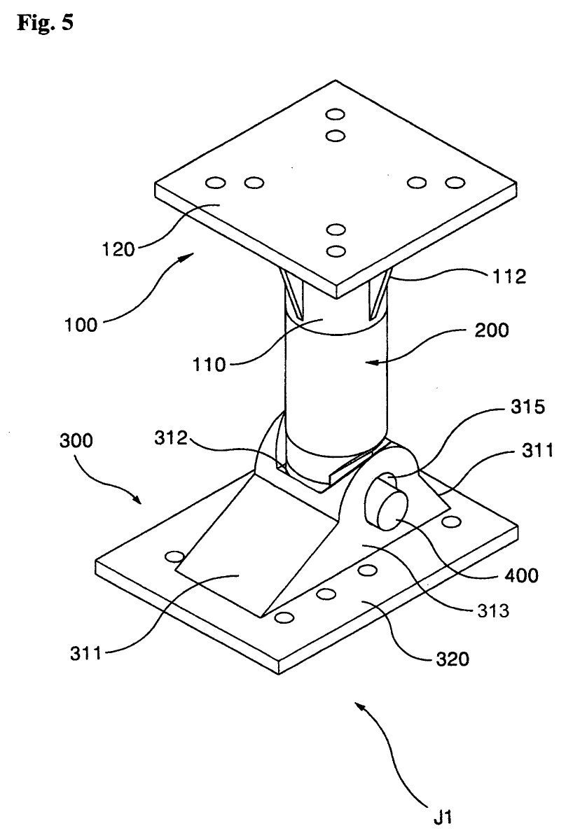

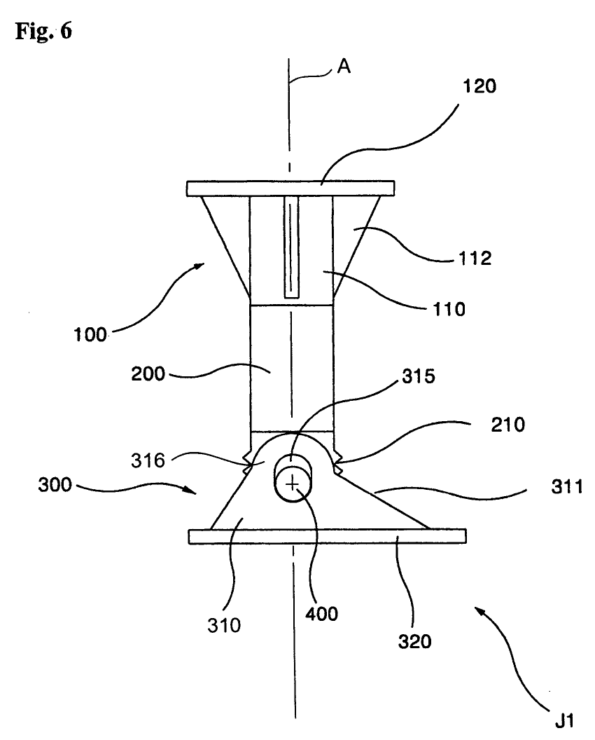

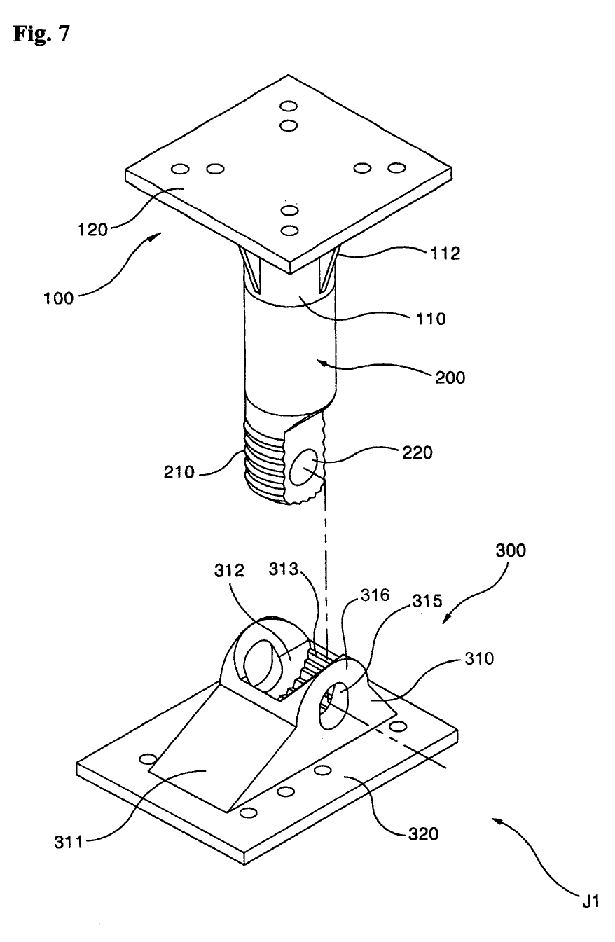

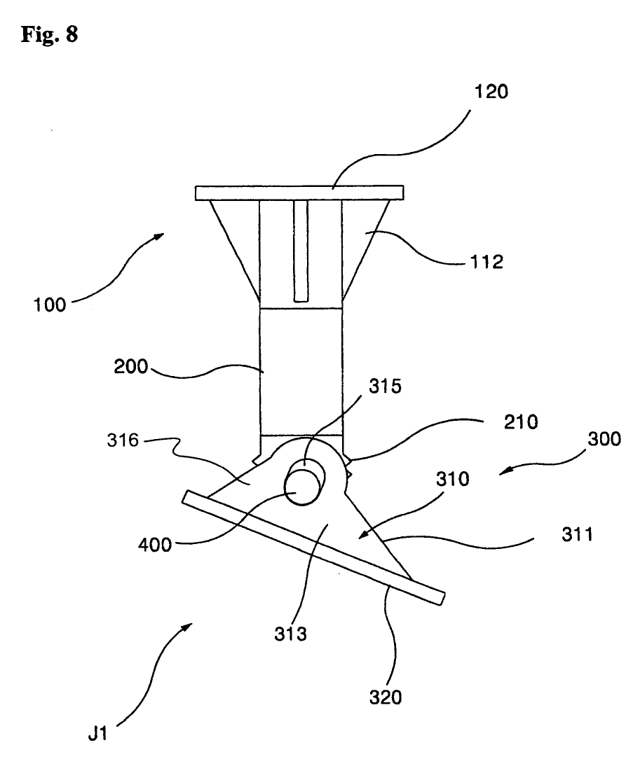

Turning now to FIGS. 5, 6, 7 and 8 collectively, which provide various views illustrating a screw jack J1 constructed as one embodiment of the principles of the present invention, which is capable of easily accommodating adjustment of its angle of inclination against an earlier erected structural element. FIG. 6 is a side view illustrating screw jack J1 usable for supporting structures, with a capacity for easily accommodating adjustment of its angle of inclination in accordance with the first embodiment of the present invention. FIG. 7 is a partially exploded perspective view illustrating screw jack J1 as usable for supporting structures, with a capacity for easily accommodating adjustment of its angle of inclination in accordance with the first embodiment of the present invention. FIG. 8 is a view illustrating an inclined operating state of screw jack J1, showing the ability of jack J1 to readily accommodate adjustment of its angle of inclination relative to the structural members to be supported.

As shown in FIGS. 5 through 8, screw jack J1 as assembled according to the principles of the present invention, may use an upper jack 100, a lower coupling shaft 200, a lower jack 300, and a steel bar such as a cylindrical pin 400.

Upper jack 100 includes upper coupling pipe 110 having a plurality of reinforcing ribs 112 formed on the outer side surface thereof, that extend between the base, or upper holder 120, and the exterior cylindrical side wall of tube, or pipe 110. Upper holder 120 is closely coupled, as by welding, to the outer side surface of upper coupling 110. Upper holder 120 may be shaped as a plate.

Lower coupling shaft 200 may be shaped as a cylindrical rod, or alternatively, as a bar. One end of lower cylindrical coupling shaft 200 is integrated with the lower portion of upper coupling pipe 110. The distal portion of the other end of lower coupling shaft 200 is formed to exhibit a predetermined curvature bearing a rack 210 that extends over the curvature of its distal terminal portions. A coupling through hole 220 extends traversely through the distal end of lower coupling shaft 200, generally perpendicularly to the teeth and valleys of rack 210.

Lower jack 300 includes chute member 310, in which pinions 313 are formed along a concave interior surface 312, to be meshed with the teeth and valleys of rack 210. The opposite side walls of chute 310 are perforated by coaxially aligned, through coupling holes 315 located on both side walls of chute 310. Lower holder 320, which is closely coupled to outer side surface of the chute member 310, in which lower holder 320 is shaped as a generally flat plate.

Steel pin 400 is inserted completely through coupling hole 220 of lower coupling shaft 200 and the adjacent, coaxially aligned coupling holes 315 through spaced-apart side walls 316 of chute member 310, so that lower coupling shaft 200 and chute member 310 are rotatably coupled together, thereby enabling the plane generally defined by the lowermost surface of lower holder 320 to be inclined over a wide range of angles relative to longitudinal axis “A” of lower coupling shaft 200, or alternatively, to be set perpendicularly to longitudinal axis “A” of lower coupling shaft 200, as is shown by FIG. 6.

Especially, chute member 310 is roughly shaped as a trapezoid such that sloped surfaces 311 are formed at the left and right faces thereof, in which concave surface 312 having a predetermined curvature is formed inside upper end of sloped surfaces 311, in which concave surface 312 forms pinion 313, in which a pair of sidewalls walls 316, having a upper portion 314 shaped as an arch with a predetermined thickness are formed adjacent to pinions 313, in which each of pair of walls 316 is perforated by an oval-shaped coupling through hole 315 that exhibits a predetermined least diameter.

Structural screw jack J1 as configured above, is operated such that: firstly, when steel pin 400 located at the lower end of screw jack J1 is raised to the upper end of through hole 315, chute member 300 connected to screw jack J1 by steel pin 400 is lowered. Then, pinion 313 of chute member 310 and rack 210 of lower coupling shaft 200, correspondingly connected to pinion 313, are released from any meshed engagement and are free to move by rotating relative to one another so that the angle of inclination of screw jack J1 can be adjusted to precisely conform to its intended disposition in the structure being erected at the job site. When screw jack J1 is subjected to a load axially along its longitudinal axis, lower coupling shaft 200 places pin 400 at the lower end of through hole 315 as represented in FIGS. 6 and 8, with pinion 313 meshing with the teeth of rack 210, to maintain the adjusted angle of inclination.

Therefore, a structural screw jack constructed according to the present invention has advantages in that, since chute member 310 located at one end of screw jack J1 can be easily controlled, screw jack J1 may be installed to brace, or support, vertically and horizontally oriented structural steel shapes by readily permitting its angle of inclination to be accurately adjusted to conform to its orientation relative to the vertically and horizontally oriented steel shapes. Accordingly, the number of process steps, such as attaching the holding steel structural shapes to the earlier erected vertical and horizontal structural steel shape as well as any cutting of the ends of the steel shapes supported by the screw jack, are reduced, thereby substantially improving the working efficiency. Also, these structural screw jacks made according to the present invention can minimize wastage of the strut supported by the screw jack due to the reduction of the number of process steps required during erection.

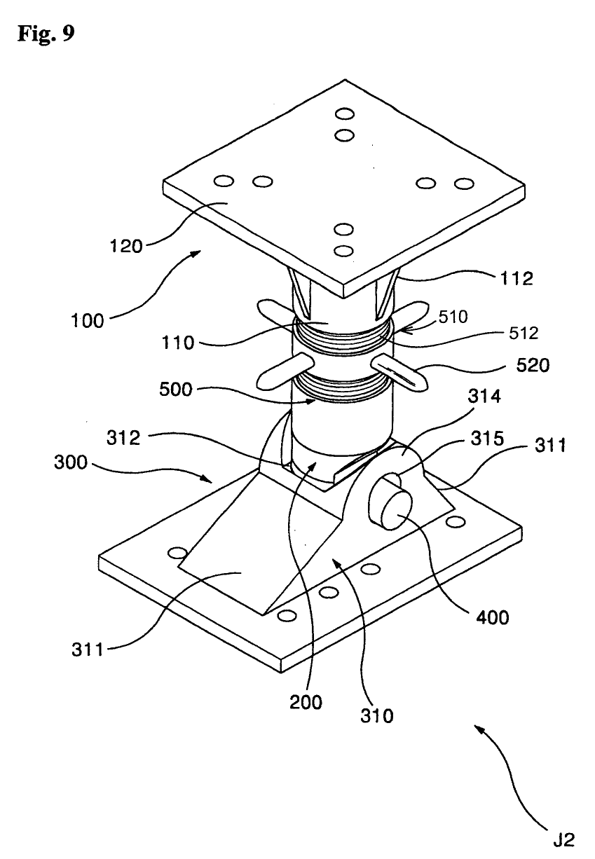

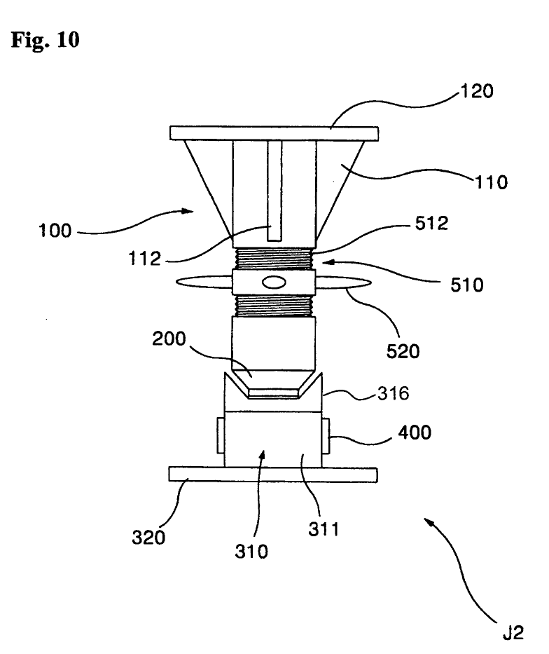

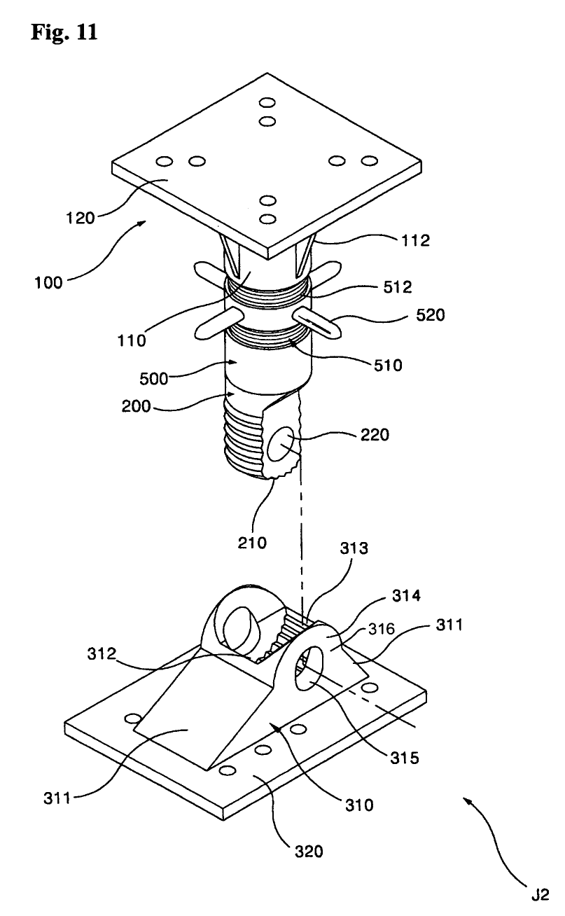

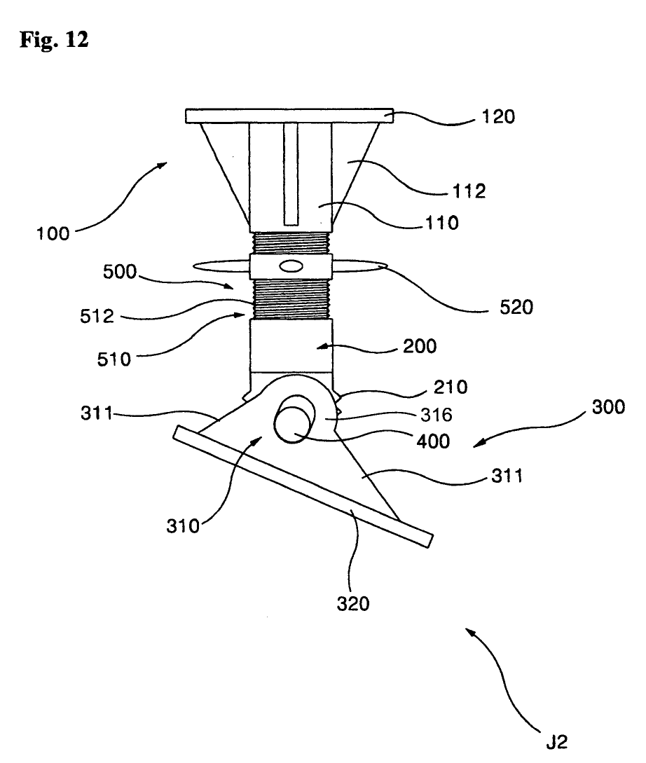

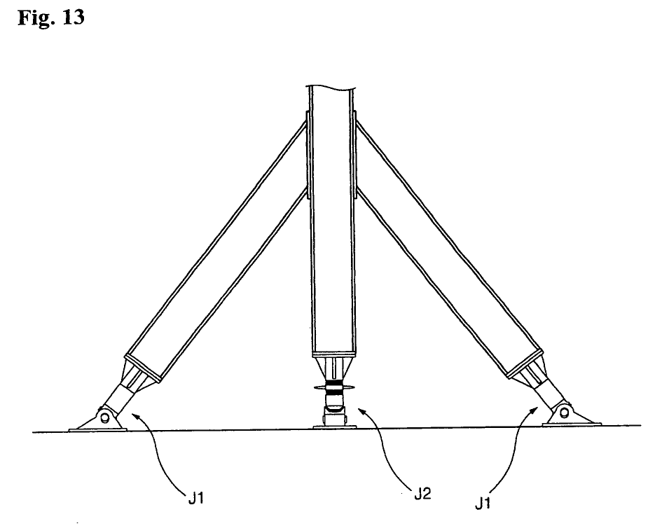

FIGS.9, 10, 11, 12 and 13 collectively provide perspective and elevation views illustrating a structural screw jack capable of easily accommodating adjustment of its angle of inclination, constructed as a second embodiment of the present invention.

As shown in FIGS.9 through 13, screw jack J2, when constructed as a second embodiment of the present invention has the same overall as the configuration of screw jack J1 in accordance with the first embodiment of the present invention, as shown in FIGS. 5 to 8. More specifically, screw jack J2 is constructed with an upper jack 100, a lower coupling shaft 200, a lower jack 300, and a steel pin 400.

Upper jack 100 may be constructed with upper coupling pipe 110 having a plurality of reinforcing ribs 112 formed on the outer side surface thereof, and an upper holder 120 closely coupled to the outer side surface of upper coupling pipe 110. Upper holder 120 may be shaped as a plate.

Lower coupling shaft 200 maybe shaped as a bar. One end of lower coupling shaft 200 is integrated at its one end to the lower portion of upper coupling pipe 110. The other and lower end of coupling shaft 200 has a predetermined curvature that forms rack 210 thereon, and is perforated by a through coupling hole 220 formed transversely to the width of rack 210, in the cross direction of lower coupling shaft 200.

Lower jack 300 includes chute member 310 containing a concave interior 312, in which pinions 313 are formed to be meshed with rack 210. Coaxially aligned through coupling holes 315 are located through both side walls 316 of chute 310. Lower holder 320 is closely coupled to outer side surface of chute 310. Lower holder 320 may be shaped as a substantially flat plate.

Steel pin 400 is inserted into coupling hole 220 of lower coupling shaft 200 and coupling holes 315 of chute member 310 so that lower coupling shaft 200 and chute 310 can be rotatably coupled together.

Screw jack J2 may also be constructed with a body 500 integrated to the lower portion of upper coupling pipe 110. Here, body 500 incorporates a screw 510 having an external helical threads 512 formed on the entire outer surfaces of its upper and lower ends. A plurality of radially extending handles 520 are mounted on the outer surface of screw 510.

Upper jack 100 and lower coupling shaft 200 are combined with intermediate body 500 to form a structure that can perform the functions of the adjustable screw jacks generally used in the construction sites.

Screw jack J2, as configured above, is operated so that: firstly, when steel pin 400 located at lower side of screw jack J1 is raised, chute 310 connected to screw jack J1 by steel pin 400 is lowered. Then, pinion 313 of chute 310 and rack 210 of lower coupling shaft 200, corresponding to otherwise mesh with pinion 313, are free to rotate and otherwise move relative to one another so that the angle of inclination of screw jack J2 can be properly adjusted to conform to the precise orientation of earlier erected structural steel shapes that are to be braced, or otherwise supported. After that, if necessary, handles 520 of body 500 are turned to rotate screw 510 and thereby tighten, or loosen, the engagement of both sets of threads 512 with body 500 and upper coupling pipe 110, thus varying and adjusting the separation between body 500 and upper coupling pipe 110 as necessary so that screw jack J2 can vary its length and the strut, or brace, which it is supporting may be precisely installed against the earlier erected structural member without any need to cut, or trim, the length of the strut.

As apparent from the above description, the screw jack according to the present invention has advantages in that as a chute member located at one end of the screw jack is adjusted such that angles of the screw jack to be installed to vertical and horizontal shape steels can be easily adjusted, the number of processes, such as attaching a holding shape steel to vertical and horizontal shape steels, and cutting the holding shape steel, can be reduced, thereby enhancing the working efficiency, and waste of a holding shape steel can be minimized.

A structural screw jack capable of easily accommodating adjustment of its angle of inclination. The screw jack can allow the orientation of a chute located at one end of the screw jack is be adjusted to define either a right angle to the longitudinal axis of the jack, or over a range of oblique angles relative to its longitudinal axis so that the screw jack may be installed at an oblique angle between earlier installed vertical and horizontal oriented structural steel shapes, and thereby enabling a reduction in the number of process steps customarily used during field installation of diagonal braces supported by a screw jack. This concomitantly reduces the number of working process steps, such as attaching the diagonal brace, or strut, to the earlier erected horizontally and vertically oriented structural steel shapes, and substantially eliminates the need for cutting the brace, or strut in order to obtain conformity with the earlier erected shapes, thereby enhancing working efficiency while minimizing waste of the steel shapes used for bracing. The screw jack includes a lower coupling shaft, a lower jack, and a steel bar. The upper jack includes an upper coupling pipe having a plurality of reinforcing ribs formed on the outer side surface thereof, and an upper holder closely coupled to the outer side surface of the upper coupling, in which the upper holder is shaped as a plate. The lower coupling shaft is shaped as a bar. One end of the lower coupling shaft is integrated at its one end to the lower portion of the upper coupling pipe. The other end of the lower coupling shaft having a predetermined curvature forming a rack thereon and has a through hole formed in the cross direction of the lower coupling shaft. The lower jack includes a chute in which pinions are formed to be meshed with the rack, and coupling holes located at both sides of the chute member are formed. A lower holder which is closely coupled to the outer surface of the chute. A steel pin inserted into the coupling hole of the lower coupling shaft and the coupling holes of the chute member, rotatingly couples lower coupling shaft and the chute together.

Although the preferred embodiment of the present invention have been disclosed for illustrative purposes, those skilled in the art will appreciate that various modifications, additions and substitutions are possible, without departing from the scope and sprit of the invention as disclosed in the accompanying claims.

What is claimed is:

1. A screw jack for structures capable of easily adjusting its angle comprising:
an upper jack (100) including an upper coupling pipe (110) having a plurality of reinforcing ribs (112) formed on the outer side surface thereof, and an upper holder (120) closely coupled to the outer side surface of the upper coupling (110), in which the upper holder (120) is shaped as a plate;
a lower coupling shaft (200) whose one end is integratedly coupled to lower portion of the upper coupling pipe (110), and whose other end having a predetermined curvature forms a rack (210) thereon and has a coupling hole (220), in which the coupling hole (220) is formed in the cross direction of the lower coupling shaft (200);
a lower jack (300) including a chute member (310), in which pinions (313) are formed to be geared with the rack (210) and coupling holes (315) located at both sides of the chute member (310) are formed, and a lower holder (320) which is closely coupled to the outer surface of the chute member (310), in which the lower holder (320) is shaped as a plate; and
a steel bar penetratedly inserted into the coupling hole (220) of the lower coupling shaft (200) and the coupling holes (315) of the chute member (310) such that the lower coupling shaft (200) and the chute member (310) can be coupled.

2. The screw jack according to claim 1, wherein the chute member (310) is roughly shaped as a trapezoid such that sloped surfaces (311) are formed at the left and right thereof, in which a concave surface (312) having a predetermined curvature is formed inside upper end of the sloped surfaces (311), in which the concave surface (312) forms the pinions (313), in which a pair of walls (314), shaped as a arch, having a predetermined thickness are formed adjacent to the pinions, in which each of the pair of walls (314) has a coupling hole (315) having a predetermined diameter.

3. The screw jack according to claim 1, further comprising a body (500) integratedly coupled to the lower portion of the upper coupling pipe (110),
wherein the body 500 includes a screw (510) having a thread (512) formed on the entire outer surface thereof, and a plurality of handles (520) mounted on the outer surface of the screw (510), the plurality of handles being outwardly protruded.
